(19) United States
(12) Patent Application Publication
(10) Pub. No.: US 2026/0175350 A1
(43) Pub. Date: Jun. 25, 2026

(54) POLISHING PAD, POLISHING METHOD, AND METHOD OF MANUFACTURING POLISHING PAD

(71) Applicant: CANON KABUSHIKI KAISHA, Tokyo (JP)

(72) Inventors: SHOTARO NOMURA, Shizuoka (JP); HIROAKI KOMATSU, Shizuoka (JP); TAKUMI FURUKAWA, Shizuoka (JP); SHOTA SEGAWA, Shizuoka (JP); KENICHI MOCHIZUKI, Shizuoka (JP)

(21) Appl. No.: 19/424,497

(22) Filed: Dec. 18, 2025

(30) Foreign Application Priority Data
Dec. 25, 2024 (JP) 2024-229439

(51) Int. Cl. B24B 37/20; B24B 37/04

(52) U.S. Cl. CPC B24B 37/20; B24B 37/042

(57) ABSTRACT

Provided is a polishing pad that achieves the suppression of edge roll-off at an edge of an object to be polished while maintaining high global flatness and high local flatness. The polishing pad is characterized in that: D20, D50, and D80 in a surface where a bubble area ratio is maximum satisfy the following formula (1) and the following formula (2): 100 [μm]≤D50≤200 [μm] . . . (1); and |D80−D20|/D50≤1.2 . . . (2); the bubble area ratio in the surface where the bubble area ratio is maximum is 70 area % or more and 95 area % or less; and the Asker A hardness of the resin sheet measured at 25° C. is 40 or more.

### BACKGROUND

### Field of the Technology

The present disclosure relates to a polishing pad, a polishing method, and a method of manufacturing a polishing pad.

### Description of the Related Art

Hitherto, polishing with free abrasive grains has been performed as a method for precisely polishing the surface of an object to be polished, such as: a glass substrate used in, for example, a lens or a display mask blank; a semiconductor wafer including an element or a compound, such as silicon, silicon carbide, gallium nitride, gallium oxide, or diamond; a semiconductor device including a silicon oxide insulating film and a metal, such as copper, tungsten, or any other barrier metal; or a hard disk, to perform pattern transfer or planarization. In the polishing with the free abrasive grains, the following mode is generally adopted: a slurry containing the free abrasive grains is supplied between the object to be polished and a polishing pad, and during the supply, the object to be polished and the polishing pad are oscillated and brought into abutment with each other while being individually rotated.

In recent years, particularly in free abrasive grain polishing related to semiconductors, along with demands for finer processing accuracy and improved productivity, there has been an increasing demand for the flattening of the object to be polished.

The flatness of the object to be polished is specifically evaluated by, for example, global flatness, which pays attention to the overall difference in height of the polished surface of the object to be polished, local flatness, which pays attention to a difference in height within the surface after the division of the object to be polished into chips, and edge roll-off, which pays attention to a difference in height between an edge and a central portion in the polished surface of the object to be polished. The achievement of compatibility between those parameters has been required.

The deterioration of the global flatness is mainly caused by the following: the slurry in the central portion of the object to be polished is discharged and exhausted by sliding, and the rotation of the polishing pad and the object to be polished, and hence the polishing does not proceed uniformly. In addition, the deterioration of the local flatness is caused by the non-uniformity of a slurry holding amount due to the non-uniformity of a pore diameter, or by the non-uniformity of a contact point between the pad and the slurry at a micro level. Accordingly, in, for example, Japanese Patent Laid-Open No. 2022-98103, there is a proposal of a polishing pad, which sharpens its bubble diameter distribution to uniformize the holding amount of a slurry at a micro level and a contact point with the slurry, and which is improved in slurry holding property by using communicating bubbles.

However, the configuration of Japanese Patent Laid-Open No. 2022-98103 has a problem such as edge roll-off at a terminal of an object to be polished owing to the ease of deformation of its shape at the time of pressurization, which is caused by the fact that the communicating bubbles are used, and hence a further improvement has been required.

### SUMMARY

The present disclosure is directed to providing a polishing pad that achieves the suppression of edge roll-off at an edge of an object to be polished while maintaining high global flatness and high local flatness. The present disclosure is also directed to providing a polishing method that achieves the suppression of the edge roll-off at the edge of the object to be polished while maintaining high global flatness and high local flatness. The present disclosure is also directed to providing a method of manufacturing a polishing pad that achieves the suppression of the edge roll-off at the edge of the object to be polished while maintaining high global flatness and high local flatness.

In order to solve the above-mentioned problems, the present disclosure provides a polishing pad for polishing an object to be polished with free abrasive grains, the polishing pad including a resin sheet having a plurality of bubbles, wherein, when cut surfaces obtained by cutting the resin sheet perpendicularly to a thickness direction of the resin sheet are determined from a measurement result of X-ray CT of the resin sheet, and a ratio of a total value of areas of openings of recesses derived from the plurality of bubbles in each of the cut surfaces to an area of the cut surface is defined as a bubble area ratio, the resin sheet has, out of the cut surfaces, a surface where the bubble area ratio is maximum, wherein, when a diameter corresponding to a cumulative frequency of 20% of area-equivalent circle diameters of the plurality of bubbles in the surface where the bubble area ratio is maximum is defined as D20 [μm], a diameter corresponding to a cumulative frequency of 50% of the area-equivalent circle diameters of the plurality of bubbles in the surface where the bubble area ratio is maximum is defined as D50 [μm], and a diameter corresponding to a cumulative frequency of 80% of the area-equivalent circle diameters of the plurality of bubbles in the surface where the bubble area ratio is maximum is defined as D80 [μm], the D20, the D50, and the D80 in the surface where the bubble area ratio is maximum satisfy the following formula (1) and the following formula (2):

$$100 [ μm ] \leq D 50 \leq 200 [ μm ] ; and \qquad ( 1 )$$

$$\vert D 80 - D 20 \vert / D 50 \leq 1.2 , \qquad ( 2 )$$

wherein the bubble area ratio in the surface where the bubble area ratio is maximum is 70 area % or more and 95 area % or less, and wherein the resin sheet has an Asker A hardness of 40 or more, which is measured with an indenter having a diameter of 0.79 mm at a tip at 25° C.

The present disclosure also provides a polishing method using a polishing pad for polishing an object to be polished with free abrasive grains, the polishing pad being the above-mentioned polishing pad, the polishing method including exposing one of the surface where the bubble area ratio is maximum or a surface in a vicinity thereof to a surface of the resin sheet when one of the surface where the bubble area ratio is maximum or the surface in the vicinity thereof is unexposed to the surface of the resin sheet.

The present disclosure also provides a method of manufacturing a polishing pad, the method including introducing an uncured resin into a coaxial centrifugal molding apparatus, forming an uncured resin layer on an inner peripheral surface of the coaxial centrifugal molding apparatus with a centrifugal force, and heating and curing the uncured resin layer to produce a resin sheet, wherein the resin sheet has a plurality of bubbles, wherein, when cut surfaces obtained by cutting the resin sheet perpendicularly to a thickness direction of the resin sheet are determined from a measurement result of X-ray CT of the resin sheet, and a ratio of a total value of areas of openings of recesses derived from the plurality of bubbles in each of the cut surfaces to an area of the cut surface is defined as a bubble area ratio, the resin sheet has, out of the cut surfaces, a surface where the bubble area ratio is maximum, wherein, when a diameter corresponding to a cumulative frequency of 20% of area-equivalent circle diameters of the plurality of bubbles in the surface where the bubble area ratio is maximum is defined as D20 [μm], a diameter corresponding to a cumulative frequency of 50% of the area-equivalent circle diameters of the plurality of bubbles in the surface where the bubble area ratio is maximum is defined as D50 [μm], and a diameter corresponding to a cumulative frequency of 80% of the area-equivalent circle diameters of the plurality of bubbles in the surface where the bubble area ratio is maximum is defined as D80 [μm], the D20, the D50, and the D80 in the surface where the bubble area ratio is maximum satisfy the following formula (1) and the following formula (2):

$$100 [ μm ] \leq D 50 \leq 200 [ μm ] ; and \qquad ( 1 )$$

$$\vert D 80 - D 20 \vert / D 50 \leq 1.2 , \qquad ( 2 )$$

wherein the bubble area ratio in the surface where the bubble area ratio is maximum is 70 area % or more and 95 area % or less, and wherein the resin sheet has an Asker A hardness of 40 or more, which is measured with an indenter having a diameter of 0.79 mm at a tip at 25° C.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view for illustrating the concepts of a bubble-derived recess and an opening thereof in the present disclosure.

FIG. 1B is a cross-sectional view for illustrating the concepts of the bubble-derived recess and the opening thereof in the present disclosure.

FIG. 2 is a conceptual diagram for describing the area-equivalent circle diameter of the opening of the bubble-derived recess.

FIG. 3 is a schematic diagram for illustrating a configuration example of a centrifugal molding machine to be used in centrifugal molding.

FIG. 4 is a schematic diagram of a method of defining a measurement surface in X-ray CT apparatus measurement and analysis.

### DESCRIPTION OF THE EMBODIMENTS

In the present disclosure, the description “XX or more and YY or less” or “XX to YY” representing a numerical range means a numerical range including a lower limit and an upper limit that are end points unless otherwise stated.

### First Embodiment

A first embodiment is directed to a polishing pad.

The polishing pad of the present disclosure is a polishing pad for polishing an object to be polished with free abrasive grains, the polishing pad including a resin sheet having a plurality of bubbles, wherein, when cut surfaces obtained by cutting the resin sheet perpendicularly to a thickness direction of the resin sheet are determined from a measurement result of X-ray CT of the resin sheet, and a ratio of a total value of areas of openings of recesses derived from the plurality of bubbles in each of the cut surfaces to an area of the cut surface is defined as a bubble area ratio, the resin sheet has, out of the cut surfaces, a surface where the bubble area ratio is maximum, wherein, when a diameter corresponding to a cumulative frequency of 20% of area-equivalent circle diameters of the plurality of bubbles in the surface where the bubble area ratio is maximum is defined as D20 [μm], a diameter corresponding to a cumulative frequency of 50% of the area-equivalent circle diameters of the plurality of bubbles in the surface where the bubble area ratio is maximum is defined as D50 [μm], and a diameter corresponding to a cumulative frequency of 80% of the area-equivalent circle diameters of the plurality of bubbles in the surface where the bubble area ratio is maximum is defined as D80 [μm], the D20, the D50, and the D80 in the surface where the bubble area ratio is maximum satisfy the following formula (1) and the following formula (2):

$$100 [ μm ] \leq D 50 \leq 200 [ μm ] ; and \qquad ( 1 )$$

$$\vert D 80 - D 20 \vert / D 50 \leq 1.2 , \qquad ( 2 )$$

wherein the bubble area ratio in the surface where the bubble area ratio is maximum is 70 area % or more and 95 area % or less, and wherein the resin sheet has an Asker A hardness of 40 or more, which is measured with an indenter having a diameter of 0.79 mm at a tip at 25° C.

In the present disclosure, the term “surface in the vicinity thereof” means a surface in the range of +200 μm in a depth direction from the surface where the bubble area ratio is maximum. The bubble distribution is continuous. Accordingly, it is conceivable that the surface in the vicinity thereof has bubble-derived recesses, which are substantially the same as those of the surface where the bubble area ratio is maximum, and hence exhibits substantially the same actions and effects.

According to an investigation made by the inventors, the above-mentioned polishing pad can provide a polishing pad and a polishing method each of which achieves the suppression of edge roll-off at an edge of the object to be polished while maintaining high global flatness and high local flatness. Details of the foregoing are described below.

As described above, the global flatness depends on the uniformity of slurry holding in a relatively macroscopic range of the pad, and the local flatness depends on a slurry holding property in a relatively microscopic range of the pad and the uniformity of a contact point between the pad and a slurry.

Compared to those indices, edge roll-off, which is similarly an index related to flatness, is largely dependent on the elasticity and rigidity of the pad. In view of the foregoing, an approach to improving the rigidity of a material for the pad is conceivable, but in that case, adverse effects such as scratching are highly likely to occur.

For this reason, the pad needs to have a certain hardness and maintain rigidity as a structure. In addition, the inventors have conceived that the achievement of the global flatness and the local flatness by a method such as the establishment of communication between the bubbles, which is accompanied by a reduction in rigidity of the pad, is essentially limited as an approach to achieving compatibility with the edge roll-off.

From this viewpoint, it can be said that an improvement in local flatness by the uniformization of a microscopic structure, that is, the sharpening of the distribution of the diameters of the openings of the recesses derived from the bubbles in the surface where the bubble area ratio is maximum or the surface in the vicinity thereof is achievable without any reduction in rigidity of the pad, and is an approach effective in alleviating the edge roll-off of a pad having a certain hardness or higher.

In view of the foregoing, the inventors have investigated a structure that can similarly improve a slurry holding property without any reduction in rigidity of the pad, that is, through use of closed bubbles instead of communicating bubbles, to thereby alleviate the edge roll-off while improving the global flatness.

In the first place, in free abrasive grain polishing, a slurry is constantly supplied between the polishing pad and the object to be polished, and hence a phenomenon in which a holding property therefor is insufficient can be said as follows: a balance between the supply and discharge of the slurry between the polishing pad and the object to be polished is lost to result in excessive discharge.

In view of the foregoing, the inventors have not only sought to improve the slurry holding property to suppress the discharge, but also searched for a structure for causing the supplied amount of the slurry to rapidly penetrate from the peripheral edge portion of the pad to the central portion thereof. Thus, the inventors have found that the structure is achievable in the presence of a certain density or more of the openings of the recesses derived from the bubbles.

Although details about the foregoing have not been elucidated yet, the inventors have presumed as described below. The slurry supplied between the polishing pad and the object to be polished, or a free abrasive grain thereof on a more microscopic scale penetrates from the peripheral edge portion of the pad to the central portion thereof by moving between the recesses derived from the bubbles.

Accordingly, when a certain density or more of the openings of the recesses derived from the bubbles are present, the frequency of movement between the recesses derived from the bubbles is increased non-linearly by an increase in number of the bubbles and a reduction in distance between the bubbles. Accordingly, it is conceivable that the non-linear increase leads to an improvement in penetrability of the slurry into the central portion of the pad, and hence the global flatness is improved.

In view of the above-mentioned investigation, the inventors have found a configuration that achieves, in closed bubbles, a bubble distribution, in which the distribution of the diameters of the openings of the recesses derived from the bubbles is sharp, and which achieves the area ratio of the openings that can achieve sufficient inter-bubble movement of the abrasive grain. As a result, in a pad having a certain hardness or higher, edge roll-off can be alleviated while global flatness and local flatness are improved.

The present disclosure is specifically described below.

The polishing pad of the present disclosure is a polishing pad for polishing an object to be polished with free abrasive grains. In the present disclosure, the polishing pad includes the resin sheet having a plurality of bubbles.

In the present disclosure, the cut surfaces obtained by cutting the resin sheet perpendicularly to the thickness direction of the resin sheet are determined from the measurement result of the X-ray CT of the resin sheet, and the ratio of the total value of the areas of the openings of the recesses derived from the plurality of bubbles in each of the cut surfaces to the area of the cut surface is defined as a bubble area ratio. At this time, in the present disclosure, the resin sheet has, out of the cut surfaces, the surface where the bubble area ratio is maximum.

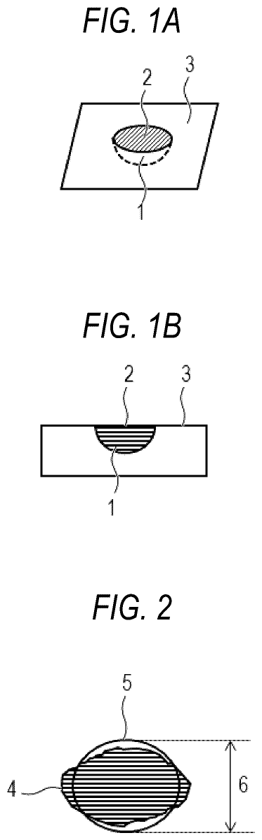

A bubble in the surface where the bubble area ratio is maximum or a surface in the vicinity thereof is schematically illustrated in each of FIG. 1A and FIG. 1B. As illustrated in each of the figures, the bubble in the surface where the bubble area ratio is maximum or the surface in the vicinity thereof, which is represented by reference numeral 3, includes an opening 2 of the recess derived from the bubble and a recess 1 derived from the bubble.

In the present disclosure, when the diameter corresponding to a cumulative frequency of 50% of the area-equivalent circle diameters of the recesses derived from the plurality of bubbles in the surface where the bubble area ratio is maximum is defined as D50 [μm], the D50 in the surface where the bubble area ratio is maximum satisfies the following formula (1).

$$100 [ μm ] \leq D 50 \leq 200 [ μm ] \qquad ( 1 )$$

In the present disclosure, the D50 is preferably 101 μm or more and 194 μm or less.

When the D50 falls within the above-mentioned range, the recesses derived from the bubbles can each sufficiently hold the slurry, and the slurry does not penetrate in the depth direction of the pad. Accordingly, such an event as described below, which has occurred in communicating bubbles, hardly occurs: the held slurry is pushed out at the time of the pressurization of the pad to deform the pad, to thereby cause edge roll-off.

When 100 [μm]>D50, the diameters of the openings of the recesses derived from the bubbles are so small that the slurry cannot be sufficiently held, and hence the global flatness of the object to be polished deteriorates. When D50>200 [μm], the opening diameters are so large that contact with the object to be polished becomes non-uniform between the central portion and edge portion of each of the openings, and hence the site flatness of the object to be polished reduces.

Here, a diagram for describing the area-equivalent circle diameter of each of the openings of the recesses derived from the bubbles in the present disclosure is illustrated in FIG. 2. An area-equivalent circle diameter 6 of the opening of the bubble-derived recess may be determined by calculating the diameter of a circle (an area 5 equivalent to that of the opening of the bubble-derived recess) having the same area as the area of an opening 4 of the bubble-derived recess as in a known method.

In the present disclosure, when the diameter corresponding to a cumulative frequency of 20% of the area-equivalent circle diameters of the recesses derived from the plurality of bubbles in the surface where the bubble area ratio is maximum is defined as D20 [μm], and the diameter corresponding to a cumulative frequency of 80% of the area-equivalent circle diameters of the recesses derived from the plurality of bubbles therein is defined as D80 [μm], the D20, the D50, and the D80 in the surface where the bubble area ratio is maximum satisfy the following formula (2).

$$\vert D 80 - D 20 \vert / D 50 \leq 1.2 \qquad ( 2 )$$

In the present disclosure, the ratio |D80−D20/|D50 indicates the width of the distribution of the area-equivalent circle diameters of the recesses derived from the plurality of bubbles. As the value of the width becomes larger, the distribution becomes broader, and as the value becomes smaller, the distribution becomes sharper. The ratio |D80−D20|/D50 is preferably 0.80 or more and 1.20 or less, more preferably 0.80 or more and 1.19 or less, particularly preferably 0.80 or more and 1.18 or less.

When the ratio |D80−D20|/D50 falls within the above-mentioned ranges, the distribution of the openings of the recesses derived from the bubbles becomes sharper, and hence the uniformity of the distribution is high, and the site flatness of the object to be polished is improved.

When |D80−D20|/D50>1.2, the distribution of the openings of the recesses derived from the bubbles is broad, and hence slurry holding, and a contact point between the pad and the slurry become non-uniform. Thus, the site flatness deteriorates.

In the present disclosure, the bubble area ratio in the surface where the bubble area ratio is maximum is 70 area % or more and 95 area % or less, preferably 70 area % or more and 90 area % or less, more preferably 70 area % or more and 84 area % or less.

When the bubble area ratio falls within the above-mentioned ranges, the inter-bubble movement of the abrasive grains is actively performed to improve the penetrability of the slurry, and hence the global flatness of the object to be polished becomes satisfactory. When the ratio of the total value of the areas of the openings is less than 70%, the penetrability of the slurry reduces, and hence the global flatness deteriorates. When the ratio is more than 95%, rigidity in the surface where the bubble area ratio is maximum or the surface in the vicinity thereof reduces, and hence the edge roll-off of the object to be polished worsens.

In the present disclosure, the resin sheet has an Asker A hardness of 40 or more, which is measured with an indenter having a diameter of 0.79 mm at a tip at 25° C.

When the Asker A hardness falls within the above-mentioned range, the edge roll-off can be suppressed. When the Asker A hardness is less than 40, even in the case of the above-mentioned configuration of the opening of the bubble-derived recess, the deformation of the pad occurs to make it difficult to suppress the edge roll-off.

In the present disclosure, when the surface where the bubble area ratio is maximum is unexposed, it is preferred that the average value (Dd) of the depths of the recesses derived from the plurality of bubbles and the D50 satisfy the following formula (3) after the surface where the bubble area ratio is maximum has been exposed to the surface of the resin sheet.

$$0.25 < Dd / D 50 < 1 \qquad ( 3 )$$

In the present disclosure, the ratio “Dd/D50” is more preferably 0.4 or more and 0.9 or less, still more preferably 0.50 or more and 0.81 or less. When the ratio “Dd/D50” falls within the above-mentioned ranges, a slurry holding property becomes sufficient while the deformation of the pad in the depth direction is suppressed. Accordingly, the global flatness can be improved while the edge roll-off is suppressed.

In the present disclosure, the maximum diameter of the recesses derived from the bubbles in the surface where the bubble area ratio is maximum is preferably 100 μm or more and 500 μm or less, more preferably 125 μm or more and 475 μm or less, still more preferably 150 μm or more and 475 μm or less. Such setting prevents the occurrence of non-uniformity, such as local excess of the slurry or the deficiency of a contact portion between the pad and the slurry, and hence improves the site flatness of the object to be polished.

### Second Embodiment

A second embodiment is directed to a method of manufacturing a polishing pad.

The method of manufacturing a polishing pad of the present disclosure is a method of manufacturing a polishing pad, the method including a step of introducing an uncured resin into a coaxial centrifugal molding apparatus, forming an uncured resin layer on an inner peripheral surface of the coaxial centrifugal molding apparatus with a centrifugal force, and heating and curing the uncured resin layer to produce a resin sheet, wherein the resin sheet has a plurality of bubbles, wherein, when cut surfaces obtained by cutting the resin sheet perpendicularly to a thickness direction of the resin sheet are determined from a measurement result of X-ray CT of the resin sheet, and a ratio of a total value of areas of openings of recesses derived from the plurality of bubbles in each of the cut surfaces to an area of the cut surface is defined as a bubble area ratio, the resin sheet has, out of the cut surfaces, a surface where the bubble area ratio is maximum, wherein, when a diameter corresponding to a cumulative frequency of 20% of area-equivalent circle diameters of the plurality of bubbles in the surface where the bubble area ratio is maximum is defined as D20 [μm], a diameter corresponding to a cumulative frequency of 50% of the area-equivalent circle diameters of the plurality of bubbles in the surface where the bubble area ratio is maximum is defined as D50 [μm], and a diameter corresponding to a cumulative frequency of 80% of the area-equivalent circle diameters of the plurality of bubbles in the surface where the bubble area ratio is maximum is defined as D80 [μm], the D20, the D50, and the D80 in the surface where the bubble area ratio is maximum satisfy the following formula (1) and the following formula (2):

$$100 [ μm ] \leq D 50 \leq 200 [ μm ] ; and \qquad ( 1 )$$

$$\vert D 80 - D 20 \vert / D 50 \leq 1.2 , \qquad ( 2 )$$

wherein the bubble area ratio in the surface where the bubble area ratio is maximum is 70 area % or more and 95 area % or less, and wherein the resin sheet has an Asker A hardness of 40 or more, which is measured with an indenter having a diameter of 0.79 mm at a tip at 25° C.

The items described in the first embodiment overlap with those described in the second embodiment, and hence, in particular, description of the resin sheet or the like may be omitted.

The method of manufacturing a polishing pad of the present disclosure includes the step of introducing the uncured resin into the coaxial centrifugal molding apparatus, forming the uncured resin layer on the inner peripheral surface of the coaxial centrifugal molding apparatus with a centrifugal force, and heating and curing the uncured resin layer to produce the resin sheet. The presence of such step enables the formation of the above-mentioned bubble-derived recess structure on the surface where the bubble area ratio is maximum or the surface in the vicinity thereof.

In the method of manufacturing a polishing pad of the present disclosure, in the above-mentioned step, the centrifugal force applied by the coaxial centrifugal molding apparatus is preferably 200 m/s² or more and 4,000 m/s² or less, and the viscosity of the uncured resin to be introduced into the coaxial centrifugal molding apparatus is preferably 1,000 mPa·s or more and 20,000 mPa·s or less. Such setting enables the formation of a bubble distribution for forming the above-mentioned bubble-derived recesses in the surface of the resin sheet where the bubble area ratio is maximum or a surface in the vicinity thereof.

A material for the resin sheet to be used in the present disclosure is specifically described below.

The material for the resin sheet is not particularly limited as long as the material is a thermosetting resin, and one or two or more kinds of, for example, a polyurethane resin composition, a polyacrylic resin composition, a polycarbonate resin composition, a polyamide resin composition, a polyester resin composition, and a polyepoxy resin composition may be used.

The polyurethane resin composition includes a structure in which an active hydrogen group-containing compound and an isocyanate group-containing compound are alternately repeated as constituent units.

The active hydrogen group-containing compound is an organic compound having an active hydrogen group that can react with an isocyanate group. Specific examples of the active hydrogen group include functional groups, such as a hydroxy group, a primary amino group, a secondary amino group, and a thiol group. The active hydrogen groups may be present in plural kinds and in a plural number in the active hydrogen group-containing compound.

Examples of the active hydrogen group-containing compound include a polyol compound and a polyamine compound.

Examples of the polyol compound include a linear aliphatic glycol, a branched aliphatic glycol, an alicyclic diol, a polyfunctional polyol, a polyester polyol, a polyester polycarbonate polyol, a polyether polyol, a polycarbonate polyol, and a polyfunctional polyol polymer.

Examples of the linear aliphatic glycol include 1,4-benzenedimethanol, 1,4-bis(2-hydroxyethoxy)benzene, ethylene glycol, propylene glycol, 1,3-propanediol, 1,3-butanediol, 1,5-pentanediol, 3-methyl-1,5-pentanediol, 1,6-hexanediol, 1,8-octanediol, and 1,9-nonanediol.

Examples of the branched aliphatic glycol include neopentyl glycol, 3-methyl-1,5-pentanediol, 2-methyl-1,3-propanediol, 2-butyl-2-ethyl-1,3-propanediol, and 2-methyl-1,8-octanediol.

Examples of the alicyclic diol include 1,4-cyclohexanediol, 1,4-cyclohexanedimethanol, and hydrogenated bisphenol A.

Examples of the polyfunctional polyol include glycerin, trimethylolpropane, tributylolpropane, pentaerythritol, and sorbitol.

Examples of the polyester polyol include polyethylene adipate glycol, polybutylene adipate glycol, polycaprolactone polyol, and polyhexamethylene adipate glycol.

The polyester polycarbonate polyol is, for example, a reaction product of a polyester glycol, such as polycaprolactone polyol, and an alkylene carbonate. The polyester polycarbonate polyol may also be, for example, a reaction product obtained by further causing a reaction mixture, which is obtained by causing ethylene carbonate to react with a polyhydric alcohol, to react with an organic dicarboxylic acid.

Examples of the polyether polyol include polytetramethylene ether glycol, polypropylene glycol, polyethylene glycol, and ethylene oxide-added polypropylene polyol.

The polycarbonate polyol is, for example, a reaction product of a diol, such as 1,3-propanediol, 1,4-butanediol, 1,6-hexanediol, diethylene glycol, polyethylene glycol, polypropylene glycol, or polytetramethylene ether glycol, and phosgene, a diaryl carbonate (e.g., diphenyl carbonate), or a cyclic carbonate (e.g., propylene carbonate).

Examples of the polyamine compound include 4,4′-methylenebis(2-chloroaniline) (MOCA), 4,4′-methylenedianiline, trimethylene bis(4-aminobenzoate), 2-methyl-4,6-bis(methylthio)benzene-1,3-diamine, 2-methyl-4,6-bis(methylthio)-1,5-benzenediamine, 2,6-dichloro-p-phenylenediamine, 4,4′-methylenebis(2,3-dichloroaniline), 3,5-bis(methylthio)-2,4-toluenediamine, 3,5-bis(methylthio)-2,6-toluenediamine, 3,5-diethyltoluene-2,4-diamine, 3,5-diethyltoluene-2,6-diamine, trimethylene glycol-di-p-aminobenzoate, 1,2-bis(2-aminophenylthio) ethane, and 4,4′-diamino-3,3′-diethyl-5,5′-dimethyldiphenylmethane.

Examples of the isocyanate group-containing compound include an aromatic diisocyanate, an aliphatic diisocyanate, an alicyclic diisocyanate, and a urethane prepolymer.

Examples of the aromatic diisocyanate include tolylene diisocyanate (TDI), 1,5-naphthalene diisocyanate, xylylene diisocyanate, 1,3-phenylene diisocyanate, and 1,4-phenylene diisocyanate. The examples of the aromatic diisocyanate also include diphenylmethane diisocyanate (MDI) and a modified product of diphenylmethane diisocyanate (MDI).

Examples of the modified product of diphenylmethane diisocyanate (MDI) include a carbodiimide-modified product, a urethane-modified product, an allophanate-modified product, a urea-modified product, a biuret-modified product, an isocyanurate-modified product, and an oxazolidone-modified product. Such modified product is specifically, for example, carbodiimide-modified diphenylmethane diisocyanate (carbodiimide-modified MDI).

Examples of the aliphatic diisocyanate include ethylene diisocyanate, 2,2,4-trimethylhexamethylene diisocyanate, and hexamethylene diisocyanate (HDI).

Examples of the alicyclic diisocyanate include 1,4-cyclohexane diisocyanate, 4,4′-dicyclohexylmethane diisocyanate, isophorone diisocyanate, norbornane diisocyanate, and methylenebis(4,1-cyclohexylene) diisocyanate.

A urethane prepolymer is a polymer formed by bonding a polyol and a polyisocyanate, and has an isocyanate group as a terminal group.

The resin sheet may contain a filler.

Specific examples of the filler include: inorganic powder, such as aluminum oxide, cerium oxide, titanium oxide, germanium oxide, silicon carbide, calcium carbonate, silica, carbon black, diamond, talc, or clay; inorganic fibers, such as a glass fiber and a carbon fiber; metal powder, such as iron, copper, aluminum, or nickel; metal fibers, such as an iron fiber, a copper fiber, and an aluminum fiber; organic fibers, such as a polyimide fiber, a TEFLON (trademark) fiber, and a polyester fiber; organic pigments such as an azo-based pigment; and other materials generally used in polymer chemistry, such as a gas, a fluid, and resin powder. A plurality of kinds of those fillers may be simultaneously incorporated into the resin sheet.

The amount of the filler is preferably 0.1 parts by mass or more and 40.0 parts by mass or less with respect to 100 parts by mass of the resin.

The particle diameter of the filler is preferably 10 nm or more and 500 nm or less.

The resin sheet may contain a foam stabilizer.

The foam stabilizer is, for example, a silicone-based surfactant, and one or two or more kinds of such surfactants may be used. Examples thereof include “Toray Silicone SH-193,” “Toray Silicone SH-192,” and “Toray Silicone SH-190” manufactured by Dow Corning Toray Co., Ltd.

In addition to the above-mentioned materials, a stabilizer such as an antioxidant, a lubricant, a pigment, a filler, an antistatic agent, and other additives may each be added to the resin sheet as required.

Examples of a method of forming the recesses derived from the plurality of bubbles in the surface of the resin sheet of the polishing pad where the bubble area ratio is maximum or the surface in the vicinity thereof include: mechanical foaming in which an inert gas is mixed into the uncured resin; and chemical foaming in which a foaming agent typified by water is added thereto. A hollow microcapsule or the like, which itself becomes a bubble, may also be added thereto.

Examples of the inert gas to be used in the mechanical foaming include nitrogen, oxygen, a carbon dioxide gas, a noble gas, such as helium or argon, and a mixed gas thereof such as air.

As a stirring apparatus for dispersing the inert gas in the form of fine bubbles in the mechanical foaming, a known stirring apparatus may be used without any particular limitation, and specific examples thereof include a homogenizer, a dissolver, a biaxial planetary mixer (planetary mixer), and a mechanical froth foaming machine. The shape of the stirring blade of the stirring apparatus is also not particularly limited, and the stirring blade is, for example, a whipper-type stirring blade.

Examples of the foaming agent in the chemical foaming include, in addition to water, a foaming agent containing, as a main component, a hydrocarbon having 5 or 6 carbon atoms, an organic chemical foaming agent, and a halogenated hydrocarbon.

Examples of the hydrocarbon include: chain hydrocarbons, such as butane, n-pentane, and n-hexane; and alicyclic hydrocarbons, such as cyclopentane and cyclohexane.

Examples of the organic chemical foaming agent include an azo-based compound, a nitroso compound, and a sulfonyl hydrazide compound.

Examples of the azo-based compound include azodicarbonamide, azobisisobutyronitrile, diazoaminobenzene, and barium azodicarboxylate.

Examples of the nitroso compound include N,N′-dinitrosopentamethylenetetramine and N,N′-dinitroso-N,N′-dimethylterephthalamide.

Examples of the sulfonyl hydrazide compound include p,p′-oxybis(benzenesulfonyl hydrazide) and p-toluenesulfonyl hydrazide.

Examples of the halogenated hydrocarbon include methylene chloride and hydrofluorocarbons (HFCs).

A method of manufacturing the resin sheet of the polishing pad is, for example, a centrifugal molding method.

The centrifugal molding method is a method of molding a thin-walled cylindrical sheet by: introducing a raw material for the uncured resin sheet into a cylindrical mold; rotating the mold at a high speed to form a resin raw material layer on its inner peripheral surface with a centrifugal force; and heating and curing the layer. The cylindrical sheet thus obtained is removed as a molded article from the cylindrical mold, subjected to secondary crosslinking as required, and cut into desired dimensions and a desired shape as required. Examples of a method for the cutting include known cutting methods, such as a clicker blade, a laser, and a cutter.

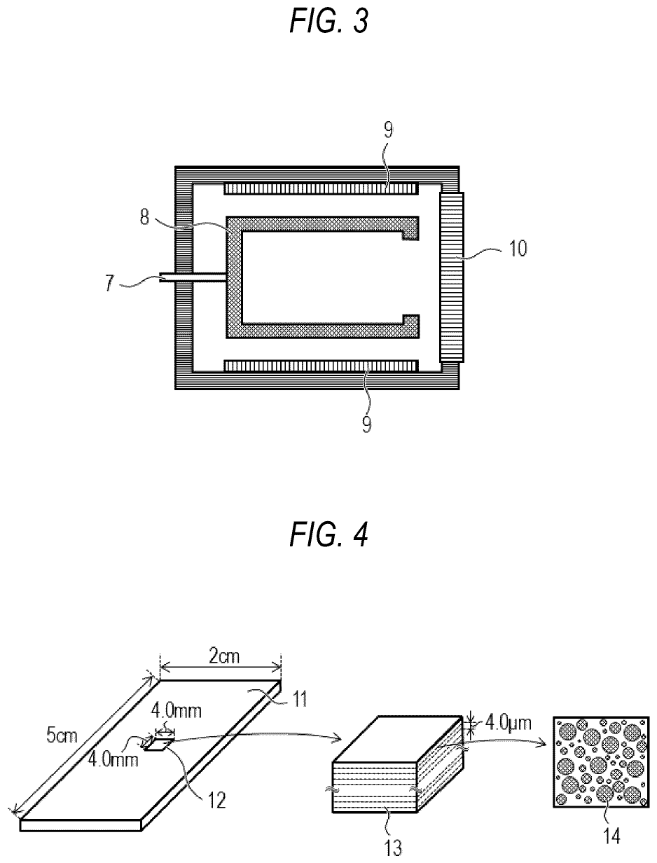

A configuration example of a centrifugal molding machine to be used in centrifugal molding is illustrated in FIG. 3. That is, as the centrifugal molding machine, there may be used a machine formed so as to include: a driving shaft 7 rotated by a motor or the like; a mold 8 in the form of a cylindrical cup (cylindrical mold 8) attached to, and rotatably supported by, the tip of the driving shaft; a heat source 9 such as a heater fixedly arranged on the outer periphery of the cylindrical mold 8; and a hatch 10 opened in a case covering the cylindrical mold 8 and the heat source 9.

The temperature of the cylindrical mold should be appropriately changed in accordance with the viscosity and foaming characteristics of the material to be used. For example, when it is desired to increase the curing speed of the resin sheet, the temperature should be increased. However, the temperature needs to be changed in accordance with purposes because a balance between the foaming and curing of the resin sheet shows different characteristics from material to material.

In addition, the number of revolutions of the cylindrical mold controls the effect of a centrifugal force caused by rotation, but the number should also be appropriately changed in accordance with the viscosity and foaming characteristics of the material to be used. For example, when it is desired to increase the foaming rate of the resin sheet on the inner surface side of the cylindrical mold, the number of revolutions may be increased to increase the centrifugal force, to thereby promote the accumulation of bubbles. In addition, when it is desired to reduce the foaming diameter of the resin sheet, the number of revolutions may be increased to increase the centrifugal force, to thereby promote the rupture of large-diameter bubbles. In addition, the same applies when it is desired to uniformize the distribution of the foaming diameters thereof. The number of revolutions may also be changed in a stepwise manner in accordance with the state of the curing or foaming of the resin.

The rotation time of the cylindrical mold should be appropriately controlled in accordance with the degree to which the effect of the above-mentioned centrifugal force is exhibited.

The method of manufacturing a polishing pad of the present disclosure preferably includes a step of exposing the surface where the bubble area ratio is maximum or a surface in the vicinity thereof to a surface of the resin sheet when the surface where the bubble area ratio is maximum or the surface in the vicinity thereof is unexposed to the surface of the resin sheet. At least, the surface where the bubble area ratio is maximum or the surface in the vicinity thereof needs to be exposed to the surface of the resin sheet before its use as a polishing pad. Any method may be used as a method for the exposure as long as a cross section can be exposed.

### Third Embodiment

A third embodiment is directed to a polishing method.

The polishing method of the present disclosure is a polishing method using a polishing pad for polishing an object to be polished with free abrasive grains, the polishing pad being the polishing pad of the present disclosure, the polishing method including a step of exposing the surface where the bubble area ratio is maximum or a surface in the vicinity thereof to a surface of the resin sheet when the surface where the bubble area ratio is maximum or the surface in the vicinity thereof is unexposed to the surface of the resin sheet.

The items described in the first embodiment and the second embodiment overlap with those described in the third embodiment, and hence, in particular, description of the resin sheet or the like may be omitted.

The polishing method of the present disclosure is a polishing method using a polishing pad for polishing an object to be polished with free abrasive grains, the polishing pad being the polishing pad of the present disclosure. A specific example thereof is described.

First, the polishing method of the present disclosure includes the step of exposing the surface where the bubble area ratio is maximum or the surface in the vicinity thereof to the surface of the resin sheet when the surface where the bubble area ratio is maximum or the surface in the vicinity thereof is unexposed to the surface of the resin sheet. At the time of polishing, the surface where the bubble area ratio is maximum or the surface in the vicinity thereof needs to be exposed to the surface of the resin sheet. Any method may be used as a method for the exposure as long as a cross section can be exposed.

Next, the object to be polished is held on the holding platen of a polishing machine. Next, the polishing pad is mounted on a polishing platen arranged to face the holding platen. When the polishing pad has a double-sided tape and release paper, at the time of the mounting of the polishing pad on the polishing platen, the release paper is peeled from the double-sided tape to expose the pressure-sensitive adhesive layer of the double-sided tape, and then the exposed pressure-sensitive adhesive layer is brought into contact with, and pressed against, the polishing platen.

Then, the object to be polished is polished with the free abrasive grains by: supplying a polishing slurry containing the abrasive grains as required between the object to be polished and the polishing pad; and rotating the polishing platen or the holding platen while pressing the object to be polished against the polishing pad at a predetermined polishing pressure.

The polishing slurry is not particularly limited, and may be a slurry to be used in conventional chemical mechanical polishing, and general abrasive grains may be used as the abrasive grains in accordance with the object to be polished. Examples thereof include ceria, silica, alumina, manganese oxide, diamond, and organic-inorganic composite abrasive grains. The abrasive grains are used alone or in combination thereof.

### [Measurement Methods and Calculation Methods for Respective Physical Properties]

Measurement methods and calculation methods for various physical properties of the polishing pad and the material are described below.

### <Measurement Methods for Diameter Corresponding to Cumulative Frequency of 20%, Diameter Corresponding to Cumulative Frequency of 50%, and Diameter Corresponding to Cumulative Frequency of 80%>

### Acquisition of Shape Data

The resin sheet (a segment 11 of a resin sheet for X-ray CT imaging) cut into a strip having a width of 2 cm and a length of 5 cm was set in an X-ray CT apparatus (TXS-32300 FDHS manufactured by Toshiba IT Control Systems Corporation), and X-ray CT measurement was performed. Measurement conditions are described below.
X-ray tube voltage [KV]: 75.000
X-ray tube voltage [mA]: 0.053
Data mode: CONE
FC function: Laks
Scan mode: FULL
Number of views: 2,000
Slice interval: 0.004
Integration: 1

### Definition of Measurement Surface

Shape data obtained for an X-ray CT imaging region 12 in the above-mentioned measurement was analyzed with image processing software VGStudio Max 2.1 manufactured by Nihon Visual Science Volume Graphics Co., Ltd., and a region measuring 4.0 mm by 4.0 mm on the maximum-area surface of the resin sheet was sliced every 4.0 μm in its thickness direction. Thus, a measurement surface 13, which was the sliced X-ray CT imaging region, was obtained. An outline of a method of defining the measurement surface up to this point is illustrated in FIG. 4.

Openings derived from bubbles and a resin part were classified by binarization processing through contrast adjustment on each of the resultant cut surfaces, and the total value of the areas of the openings derived from the bubbles (openings 14 of recesses derived from the bubbles on the measurement surface) each having a size of 2 μm or more was calculated. The ratio of the total value was calculated by dividing the total value by the area of the entire region.

In the binarization processing, a grayscale range of 129 or more was defined as the resin part.

When the surface where the area ratio of the openings of the recesses derived from the bubbles was maximum was defined as the measurement surface, the measurement surface was determined from the above-mentioned data.

In addition, when the outermost surface of the resin sheet was defined as the measurement surface, a cut surface obtained as follows was defined as the measurement surface: when the entirety of the measurement surface was set to 100%, the resin sheet was sliced from its surface side until a void part in which one bubble accounted for 10% or more of the entirety disappeared.

### Measurement of Area-Equivalent Circle Diameter

The data on the 4.0 mm×4.0 mm measurement surface obtained in the above-mentioned measurement was analyzed with ImageJ (Rasband, W. S., U.S. National Institutes of Health, Bethesda, Maryland, USA), and openings of recesses derived from bubbles and a resin part were classified by binarization processing through contrast adjustment. The area-equivalent circle diameters of the openings of the recesses derived from the bubbles each having a size of 2 μm or more on the 4.0 mm×4.0 mm measurement surface were calculated.

A diameter corresponding to a cumulative frequency of 20%, a diameter corresponding to a cumulative frequency of 50%, and a diameter corresponding to a cumulative frequency of 80% were calculated from the resultant data on the openings of the recesses derived from the bubbles.

### <Calculation Method for Ratio of Total Value of Areas of Openings>

### Acquisition of Shape Data

Data on a 4.0 mm×4.0 mm measurement surface was acquired by performing the X-ray CT measurement of the resin sheet in the same manner as in the measurement of the diameter corresponding to a cumulative frequency of 20%.

### Calculation of Ratio of Total Value of Areas of Openings

The data on the 4.0 mm×4.0 mm measurement surface obtained in the above-mentioned measurement was analyzed with image processing software VGStudio Max 2.1 manufactured by Nihon Visual Science Volume Graphics Co., Ltd., and the total value of the areas of the openings of recesses derived from bubbles each having a size of 2 μm or more in the data on the 4.0 mm×4.0 mm measurement surface was calculated. The ratio of the total value was calculated by dividing the total value by the area of the entire region.

### <Asker A Hardness of the Resin Sheet at 25° C.>

The resin sheet, which was used as it was when its thickness was 6 mm or more, or laminated to 6 mm or more when the thickness was 6 mm or less, was allowed to stand still for 16 hours in an environment at 25° C. and a humidity of 50%+5%, and then its Asker A hardness was measured five times with a type A durometer (Asker A type manufactured by Kobunshi Keiki Co., Ltd.) in conformity with JIS K 6253. The average value of the measured values was defined as the Asker A hardness of the resin sheet.

<Measurement Method for Average Value (Dd) of Depths of Recesses Derived from Bubbles in Surface where the Bubble Area Ratio is Maximum or Surface in Vicinity Thereof>

### Acquisition of Shape Data

Shape data was acquired by performing the X-ray CT measurement of the resin sheet in the same manner as in the measurement of the diameter corresponding to a cumulative frequency of 20%.

Measurement of Average Value (Dd) of Depths of Recesses Derived from Bubbles in Surface where the Bubble Area Ratio is Maximum or Surface in Vicinity Thereof

The shape data obtained in the above-mentioned measurement was analyzed with image processing software VGStudio Max 2.1 manufactured by Nihon Visual Science Volume Graphics Co. Ltd., and a 4.0 mm×4.0 mm region viewed from the surface of the resin sheet was sliced every 4.0 μm in its vertical direction. Recesses derived from bubbles and a resin part were classified by binarization processing through contrast adjustment on each of the resultant cut surfaces, and a depth from the opening of each of the bubble-derived recesses each having a size of 2 μm or more to the lowest surface thereof was calculated, followed by the determination of the average value (Dd) of the depths.

### <Measurement Method for Resin Viscosity>

The viscosity of the resin sheet 60 seconds after its melting was measured with VP-500 manufactured by HAAKE Co., Ltd.

An apparatus and conditions for the measurement are as described below.
Viscometer: rotational viscometer Viscotester VT550 (manufactured by HAAKE Co., Ltd.)
Sensor system: NV cup/NV rotor
Number of revolutions: 8.3 s⁻¹ (500 rpm)
Circulating constant temperature bath: open bath circulator DC5-K20 (manufactured by HAAKE Co., Ltd.)
Set temperature: 70° C.

### <Evaluation Methods for Global Flatness, Local Flatness, and Edge Roll-Off of Object to be Polished>

So-called X-Y groove processing (lattice groove processing) having a width of 2.0 mm, a pitch of 15 mm, and a depth of 0.5 mm was performed on the surface of the produced polishing pad 1, and the processed pad was mounted on each of the upper and lower platens of a double-sided polishing apparatus (manufactured by Fujikoshi Machinery Corp.).

20 Batches of polishing were performed in the polishing process of the (100) surfaces of five silicon single crystal wafers each having a diameter of 300 mmφ per batch while a polishing time per batch was set to 30 minutes. The flatness (global flatness, local flatness, and edge roll-off) of the 20th batch was measured, an average value was calculated for the five wafers, and a polishing rate was also measured at the same time. A colloidal silica-containing alkaline solution having a pH of 10.5 (manufactured by Fujimi Incorporated) was supplied as a slurry at 5 L/min. The number of revolutions of each of a polishing head and a platen was set to 30 rpm, and a polishing pressure was set to 70 g/cm².

The global flatness, the local flatness, and the edge roll-off were evaluated as a global backsurface-referenced ideal plane/range (GBIR), a site front least squares range (SFQR), and the SFQR of a wafer outer peripheral portion (edge SFQR in Tables 2-1, 2-2 and 2-3), respectively with a flatness-measuring apparatus (Nanometro 300TT-A manufactured by Kuroda Seiko Co., Ltd.). At this time, a SFQR in the range of 8.0×26.0 mm² near the center of the wafer was adopted as the local flatness. In addition, the edge roll-off was determined as a SFQR for each section defined as follows: the outermost periphery of the wafer having a width of 1 mm was excluded; and the range of from the peripheral edge portion of the resultant to a portion 35 mm inward therefrom was divided by radiating lines arranged at intervals of 5° from the center of the wafer serving as a starting point.

### EXAMPLES

The present disclosure is more specifically described below by way of Examples. However, the present disclosure is by no means limited by Examples. In the following formulations, the term “part(s)” means “part(s) by mass” unless otherwise specified.

### Example 1

237 Parts by mass of 2,4-tolylene diisocyanate (TDI), 412 parts by mass of polytetramethylene ether glycol (PTMG) having a number-average molecular weight of about 1,000, and 40 parts by mass of diethylene glycol were caused to react with each other, and the reaction product was degassed under heating and reduced pressure to provide a prepolymer. The isocyanate content of the prepolymer was 9.1%.

55.0 Parts by mass of the prepolymer, 45.0 parts by mass of diethyl toluene diamine (DETDA), 5.0 parts by mass of water, 0.006 parts by mass of TOYOCAT (trademark) ET (manufactured by Tosoh Corporation), and 2.0 parts by mass of a silicone-based foam stabilizer SH-193 were mixed to provide an uncured resin solution.

340 Grams of the uncured resin solution was heated to 110° C. on a preformed silicone rubber release layer, and was poured into a cylindrical mold having a diameter of 450 mm and a depth of 320 mm in a centrifugal molding machine rotating at 1,200 rpm. While the number of revolutions was maintained at 1,200 rpm for 30 minutes from the time point when the pouring was completed, the solution was cured under heating. After that, the cured product was removed from the mold to provide a resin sheet 1 having a thickness of 1.50 mm.

A double-sided tape having an adhesive layer (material:acrylic resin) on each of both the surfaces of a PET-made base material and having release paper on one surface thereof was bonded to the surface of the resultant resin sheet 1 on the side far from the cut surface at the depth where its bubble area ratio was maximum via the adhesive layer opposite to the release paper. Thus, a polishing pad 1 was obtained. Table 1-1 shows the physical properties of the resultant polishing pad 1.

TABLE 1-1

| | Polishing | Polishing | Polishing | Polishing | Polishing |
|---|---|---|---|---|---|
| | pad 1 | pad 2 | pad 3 | pad 4 | pad 5 |
| D50 [μm] | 107 | 129 | 102 | 110 | 114 |
| \|D80 − D20\|/D50 | 0.93 | 1.19 | 0.98 | 0.95 | 1.18 |
| Bubble area ratio in surface | 84% | 71% | 70% | 72% | 81% |
| where bubble area ratio is | | | | | |
| maximum | | | | | |
| Asker A hardness of the resin | 92 | 90 | 42 | 94 | 93 |
| sheet measured with indenter | | | | | |
| having diameter of 0.79 mm at | | | | | |
| tip at 25° C. | | | | | |
| Dd/D50 | 0.50 | 0.63 | 0.51 | 0.51 | 0.56 |
| Maximum diameter of bubbles | 360 | 654 | 381 | 312 | 420 |
| [μm] | | | | | |

TABLE 1-2

| | Polishing | Polishing | Polishing | Polishing | Polishing |
|---|---|---|---|---|---|
| | pad 6 | pad 7 | pad 8 | pad 9 | pad 10 |
| D50 [μm] | 101 | 194 | 108 | 123 | 101 |
| \|D80 − D20\|/D50 | 0.94 | 0.95 | 0.94 | 1.16 | 0.99 |
| Bubble area ratio in surface | 83% | 80% | 90% | 82% | 70% |
| where bubble area ratio is | | | | | |
| maximum | | | | | |
| Asker A hardness of the resin | 94 | 98 | 91 | 85 | 35 |
| sheet measured with indenter | | | | | |
| having diameter of 0.79 mm at | | | | | |
| tip at 25° C. | | | | | |
| Dd/D50 | 0.52 | 0.50 | 0.50 | 0.81 | 0.51 |
| Maximum diameter of bubbles | 371 | 463 | 359 | 473 | 395 |
| [μm] | | | | | |

TABLE 1-3

| | Polishing | Polishing | Polishing | Polishing | Polishing |
|---|---|---|---|---|---|
| | pad 11 | pad 12 | pad 13 | pad 14 | pad 15 |
| D50 [μm] | 103 | 105 | 110 | 91 | 219 |
| \|D80 − D20\|/D50 | 0.99 | 0.95 | 1.34 | 0.95 | 1.18 |
| Bubble area ratio in surface | 65% | 96% | 85% | 84% | 81% |
| where bubble area ratio is | | | | | |
| maximum | | | | | |
| Asker A hardness of the resin | 35 | 89 | 91 | 92 | 89 |
| sheet measured with indenter | | | | | |
| having diameter of 0.79 mm at | | | | | |
| tip at 25° C. | | | | | |
| Dd/D50 | 0.53 | 0.50 | 0.64 | 0.52 | 0.50 |
| Maximum diameter of bubbles | 387 | 392 | 495 | 385 | 783 |
| [μm] | | | | | |

Tables 2-1, 2-2, and 2-3 show the results of the evaluations of the global flatness, local flatness, and edge roll-off of an object to be polished.

TABLE 2-1

| | Example | Example | Example | Example | Example | Example |
|---|---|---|---|---|---|---|
| | 1 | 2 | 3 | 4 | 5 | 6 |
| Used pad | Polishing | Polishing | Polishing | Polishing | Polishing | Polishing |
| | pad 1 | pad 2 | pad 3 | pad 4 | pad 5 | pad 6 |
| GBIR | 1.02 | 1.13 | 1.17 | 1.00 | 1.00 | 1.18 |
| SFQR | 1.10 | 1.14 | 1.02 | 1.04 | 1.15 | 1.00 |
| Edge SFQR | 1.03 | 1.04 | 1.28 | 1.17 | 1.01 | 1.01 |

TABLE 2-2

| | Example | Example | Example | Comparative | Comparative |
|---|---|---|---|---|---|
| | 7 | 8 | 9 | Example 1 | Example 2 |
| Used pad | Polishing | Polishing | Polishing | Polishing | Polishing |
| | pad 7 | pad 8 | pad 9 | pad 10 | pad 11 |
| GBIR | 1.04 | 1.08 | 1.19 | 1.17 | 1.38 |
| SFQR | 1.16 | 1.06 | 1.18 | 1.07 | 1.16 |
| Edge SFQR | 1.25 | 1.19 | 1.17 | 1.37 | 1.39 |

TABLE 2-3

| | Comparative | Comparative | Comparative | Comparative |
|---|---|---|---|---|
| | Example 3 | Example 4 | Example 5 | Example 6 |
| Used pad | Polishing pad | Polishing pad | Polishing pad | Polishing pad |
| | 12 | 13 | 14 | 15 |
| GBIR | 1.11 | 1.08 | 1.43 | 1.17 |
| SFQR | 1.13 | 1.39 | 1.09 | 1.28 |
| Edge SFQR | 1.37 | 1.19 | 1.06 | 1.43 |

### Examples 2 to 9

Polishing pads 2 to 9 were each obtained in exactly the same manner as in Example 1 except that the formulation, and the rotation condition and rotation time of the cylindrical mold were changed as shown in Tables 3-1 and 3-2.

Tables 2-1 and 2-2 show the evaluation results of the resultant polishing pads 2 to 9.

TABLE 3-1

| | | Example 1 | Example 2 | Example 3 | Example 4 | Example 5 |
|---|---|---|---|---|---|---|
| | | Polishing | Polishing | Polishing | Polishing | Polishing |
| | | pad 1 | pad 2 | pad 3 | pad 4 | pad 5 |
| Formulation | TDI | 237 | 237 | 237 | 237 | 237 |
| | [part(s) by mass] | | | | | |
| | PTMG | 412 | 412 | 412 | 412 | 412 |
| | [part(s) by mass] | | | | | |
| | Diethylene glycol | 40 | 40 | 40 | 40 | 40 |
| | [part(s) by mass] | | | | | |
| | Prepolymer | 55 | 55 | 60 | 60 | 55 |
| | [part(s) by mass] | | | | | |
| | Diethyl toluene | 45 | 45 | 40 | 40 | 45 |
| | diamine | | | | | |
| | [part(s) by mass] | | | | | |
| | Water | 5 | 4.5 | 4.5 | 4.5 | 5 |
| | [part(s) by mass] | | | | | |
| | TOYOCAT ET | 0.006 | 0.006 | 0.006 | 0.006 | 0.006 |
| | [part(s) by mass] | | | | | |
| | Foam stabilizer | 2 | 2 | 2.4 | 2.4 | 2 |
| | [part(s) by mass] | | | | | |
| | Resin viscosity | 2,674 | 2,987 | 1,583 | 1,589 | 2,847 |
| | [mPa · s] | | | | | |
| Centrifugal | Number of | 1,200 | 600 | 1,200 | 1,200 | 1,000 |
| molding | revolutions [rpm] | | | | | |
| apparatus | Time | 30 | 30 | 30 | 30 | 30 |
| operation | [min] | | | | | |
| conditions | Mold set | 110 | 110 | 110 | 110 | 110 |
| | temperature [° C.] | | | | | |

TABLE 3-2

| | | Example 6 | Example 7 | Example 8 | Example 9 |
|---|---|---|---|---|---|
| | | Polishing pad 6 | Polishing pad 7 | Polishing pad 8 | Polishing pad 9 |
| Formulation | TDI | 237 | 237 | 237 | 237 |
| | [part(s) by mass] | | | | |
| | PTMG | 412 | 412 | 412 | 412 |
| | [part(s) by mass] | | | | |
| | Diethylene Glycol | 40 | 40 | 40 | 40 |
| | [part(s) by mass] | | | | |
| | Prepolymer | 60 | 60 | 55 | 70 |
| | [part(s) by mass] | | | | |
| | Diethyl toluene diamine | 40 | 40 | 45 | 30 |
| | [part(s) by mass] | | | | |
| | Water | 5 | 5 | 6 | 5 |
| | [part(s) by mass] | | | | |
| | TOYOCAT ET | 0.006 | 0.006 | 0.006 | 0.06 |
| | [part(s) by mass] | | | | |
| | Foam stabilizer | 2.2 | 1 | 2 | 2 |
| | [part(s) by mass] | | | | |
| | Resin viscosity | 1,583 | 1,596 | 2,878 | 2,428 |
| | [mPa · s] | | | | |
| Centrifugal | Number of revolutions | 1,200 | 1,200 | 1,200 | 600 |
| molding | [rpm] | | | | |
| apparatus | Time | 30 | 30 | 30 | 30 |
| operation | [min] | | | | |
| conditions | Mold set temperature | 110 | 110 | 110 | 110 |
| | [° C.] | | | | |

TABLE 3-3

| | | Comparative | Comparative | Comparative |
|---|---|---|---|---|
| | | Example 1 | Example 2 | Example 3 |
| | | Polishing pad 10 | Polishing pad 11 | Polishing pad 12 |
| Formulation | TDI | 237 | 237 | 237 |
| | [part(s) by mass] | | | |
| | PTMG | 412 | 412 | 412 |
| | [part(s) by mass] | | | |
| | Diethylene Glycol | 40 | 40 | 40 |
| | [part(s) by mass] | | | |
| | Prepolymer | 60 | 60 | 55 |
| | [part(s) by mass] | | | |
| | Diethyl toluene diamine | 40 | 40 | 45 |
| | [part(s) by mass] | | | |
| | Water | 4 | 3 | 6.5 |
| | [part(s) by mass] | | | |
| | TOYOCAT ET | 0.006 | 0.006 | 0.006 |
| | [part(s) by mass] | | | |
| | Foam stabilizer | 1.5 | 1.5 | 2 |
| | [part(s) by mass] | | | |
| | Resin viscosity | 1,574 | 1,566 | 2,747 |
| | [mPa · s] | | | |
| Centrifugal | Number of revolutions | 1,200 | 1,200 | 1,200 |
| molding | [rpm] | | | |
| apparatus | Time | 30 | 30 | 30 |
| operation | [min] | | | |
| conditions | Mold set temperature | 110 | 110 | 110 |
| | [° C.] | | | |

TABLE 3-4

| | | Comparative | Comparative | Comparative |
|---|---|---|---|---|
| | | Example 4 | Example 5 | Example 6 |
| | | Polishing pad 13 | Polishing pad 14 | Polishing pad 15 |
| Formulation | TDI | 237 | 237 | 237 |
| | [part(s) by mass] | | | |
| | PTMG | 412 | 412 | 412 |
| | [part(s) by mass] | | | |
| | Diethylene Glycol | 40 | 40 | 40 |
| | [part(s) by mass] | | | |
| | Prepolymer | 55 | 60 | 60 |
| | [part(s) by mass] | | | |
| | Diethyl toluene diamine | 45 | 40 | 40 |
| | [part(s) by mass] | | | |
| | Water | 5 | 5 | 5 |
| | [part(s) by mass] | | | |
| | TOYOCAT ET | 0.006 | 0.006 | 0.006 |
| | [part(s) by mass] | | | |
| | Foam stabilizer | 3 | 2.6 | 0.5 |
| | [part(s) by mass] | | | |
| | Resin viscosity | 2,644 | 1,575 | 1,588 |
| | [mPa · s] | | | |
| Centrifugal | Number of revolutions | 600 | 1,200 | 1,200 |
| molding | [rpm] | | | |
| apparatus | Time | 30 | 30 | 30 |
| operation | [min] | | | |
| conditions | Mold Set Temperature | 110 | 110 | 110 |
| | [° C.] | | | |

### Comparative Examples 1 to 6

Polishing pads 10 to 15 were each obtained in exactly the same manner as in Example 1 except that the formulation, and the rotation condition and rotation time of the cylindrical mold were changed as shown in Tables 3-3 and 3-4.

Tables 2-2 and 2-3 show the evaluation results of the resultant polishing pads 10 to 15.

In each of Examples 1 to 9, the global flatness, local flatness, and edge roll-off of the object to be polished were satisfactory because the area-equivalent circle diameters of bubble-derived recesses and the distribution thereof, the total area of the openings of the recesses, and the hardness of the resin sheet satisfied the definition of claim 1. The results of Example 1 were particularly satisfactory.

In each of Comparative Examples 1 to 6, any of the items, that is, the global flatness, local flatness, and edge roll-off of the object to be polished showed a low value because the area-equivalent circle diameters of bubble-derived recesses and the distribution thereof, the total area of the openings of the recesses, and the hardness of the resin sheet did not satisfy the definition of claim 1.

According to the present disclosure, there can be provided a polishing pad and a polishing method each of which achieves the suppression of edge roll-off at an edge of an object to be polished while maintaining high global flatness and high local flatness.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-229439, filed Dec. 25, 2024, which is hereby incorporated by reference herein in its entirety.

What is claimed is:

1. A polishing pad for polishing an object to be polished with free abrasive grains,
the polishing pad comprising a resin sheet having a plurality of bubbles,
wherein, when cut surfaces obtained by cutting the resin sheet perpendicularly to a thickness direction of the resin sheet are determined from a measurement result of X-ray CT of the resin sheet, and a ratio of a total value of areas of openings of recesses derived from the plurality of bubbles in each of the cut surfaces to an area of the cut surface is defined as a bubble area ratio,
the resin sheet has, out of the cut surfaces, a surface where the bubble area ratio is maximum,
wherein, when a diameter corresponding to a cumulative frequency of 20% of area-equivalent circle diameters of the plurality of bubbles in the surface where the bubble area ratio is maximum is defined as D20 [μm], a diameter corresponding to a cumulative frequency of 50% of the area-equivalent circle diameters of the plurality of bubbles in the surface where the bubble area ratio is maximum is defined as D50 [μm], and a diameter corresponding to a cumulative frequency of 80% of the area-equivalent circle diameters of the plurality of bubbles in the surface where the bubble area ratio is maximum is defined as D80 [μm],
the D20, the D50, and the D80 in the surface where the bubble area ratio is maximum satisfy the following formula (1) and the following formula (2):
$$100 [ μm ] \leq D 50 \leq 200 [ μm ] ; and \qquad ( 1 )$$
$$\vert D 80 - D 20 \vert / D 50 \leq 1.2 , \qquad ( 2 )$$
wherein the bubble area ratio in the surface where the bubble area ratio is maximum is 70 area % or more and 95 area % or less, and
wherein an Asker A hardness of the resin sheet at 25° C. is 40 or more.

2. The polishing pad according to claim 1, wherein an average value (Dd) of depths of the recesses derived from the plurality of bubbles and the D50 in the surface where the bubble area ratio is maximum satisfy the following formula (3).
$$0.25 < Dd / D 50 < 1 \qquad ( 3 )$$

3. The polishing pad according to claim 1, wherein a maximum diameter of the recesses derived from the bubbles in the surface where the bubble area ratio is maximum is 100 μm or more and 500 μm or less.

4. A polishing method using a polishing pad for polishing an object to be polished with free abrasive grains, the polishing pad being the polishing pad of any one of claims 1 to 3, the polishing method comprising exposing one of the surface where the bubble area ratio is maximum or a surface in a vicinity thereof to a surface of the resin sheet when one of the surface where the bubble area ratio is maximum or the surface in the vicinity thereof is unexposed to the surface of the resin sheet.

5. A method of manufacturing a polishing pad, the method comprising introducing an uncured resin into a coaxial centrifugal molding apparatus, forming an uncured resin layer on an inner peripheral surface of the coaxial centrifugal molding apparatus with a centrifugal force, and heating and curing the uncured resin layer to produce a resin sheet,
wherein the resin sheet has a plurality of bubbles,
wherein, when cut surfaces obtained by cutting the resin sheet perpendicularly to a thickness direction of the resin sheet are determined from a measurement result of X-ray CT of the resin sheet, and a ratio of a total value of areas of openings of recesses derived from the plurality of bubbles in each of the cut surfaces to an area of the cut surface is defined as a bubble area ratio,
the resin sheet has, out of the cut surfaces, a surface where the bubble area ratio is maximum,
wherein, when a diameter corresponding to a cumulative frequency of 20% of area-equivalent circle diameters of the plurality of bubbles in the surface where the bubble area ratio is maximum is defined as D20 [μm], a diameter corresponding to a cumulative frequency of 50% of the area-equivalent circle diameters of the plurality of bubbles in the surface where the bubble area ratio is maximum is defined as D50 [μm], and a diameter corresponding to a cumulative frequency of 80% of the area-equivalent circle diameters of the plurality of bubbles in the surface where the bubble area ratio is maximum is defined as D80 [μm],
the D20, the D50, and the D80 in the surface where the bubble area ratio is maximum satisfy the following formula (1) and the following formula (2):
$$100 [ μm ] \leq D 50 \leq 200 [ μm ] ; and \qquad ( 1 )$$
$$\vert D 80 - D 20 \vert / D 50 \leq 1.2 , \qquad ( 2 )$$
wherein the bubble area ratio in the surface where the bubble area ratio is maximum is 70 area % or more and 95 area % or less, and
wherein an Asker A hardness of the resin sheet at 25° C. is 40 or more.

6. The method of manufacturing a polishing pad according to claim 5,
wherein the centrifugal force is 200 m/s² or more and 4,000 m/s² or less, and
wherein a viscosity of the uncured resin to be introduced is 1,000 mPa·s or more and 20,000 mPa·s or less.

7. The method of manufacturing a polishing pad according to claim 5, comprising exposing one of the surface where the bubble area ratio is maximum or a surface in a vicinity thereof to a surface of the resin sheet when one of the surface where the bubble area ratio is maximum or the surface in the vicinity thereof is unexposed to the surface of the resin sheet.
